(19) United States
(12) Patent Application Publication
(10) Pub. No.: US 2016/0093297 A1
(43) Pub. Date: Mar. 31, 2016

(54) METHOD AND APPARATUS FOR EFFICIENT, LOW POWER FINITE STATE TRANSDUCER DECODING

(71) Applicants: MICHAEL E. DEISHER, Hillsboro, OR (US); OHAD FALIK, Kfar Saba (IL); KISUN YOU, Seoul (KR)

(72) Inventors: MICHAEL E. DEISHER, Hillsboro, OR (US); OHAD FALIK, Kfar Saba (IL); KISUN YOU, Seoul (KR)

(21) Appl. No.: 14/497,693

(22) Filed: Sep. 26, 2014

(51) Int. Cl. G10L 15/14; G10L 21/10

(52) U.S. Cl. CPC G10L 15/14; G10L 21/10

(57) ABSTRACT

A system, apparatus and method for efficient, low power, finite state transducer decoding. For example, one embodiment of a system for performing speech recognition comprises: a processor to perform feature extraction on a plurality of digitally sampled speech frames and to responsively generate a feature vector; an acoustic model likelihood scoring unit communicatively coupled to the processor over a communication interconnect to compare the feature vector against a library of models of various known speech sounds and responsively generate a plurality of scores representing similarities between the feature vector and the models; and a weighted finite state transducer (WFST) decoder communicatively coupled to the processor and the acoustic model likelihood scoring unit over the communication interconnect to perform speech decoding by traversing a WFST graph using the plurality of scores provided by the acoustic model likelihood scoring unit.

### BACKGROUND

1. Field of the Invention

This invention relates generally to the field of computer processors. More particularly, the invention relates to an apparatus and method for efficient, low power finite state transducer decoding.

2. Description of the Related Art

Accurate large vocabulary continuous speech recognition (LVCSR) on battery powered personal mobile devices requires significant compute, memory, and energy. So-called “embedded” speech recognizers currently deployed on smartphones significantly compromise accuracy in order to fit within platform constraints. Very long speech recognition sessions (e.g., meeting transcription, etc.) do not provide satisfactory results in that speech transcription accuracy is poor and battery life is significantly reduced.

### BRIEF DESCRIPTION OF THE DRAWINGS

A better understanding of the preset invention can be obtained from the following detailed description in conjunction with the following drawings, in which:

FIG. 1A is a block diagram illustrating both an exemplary in-order pipeline and an exemplary register renaming, out-of-order issue/execution pipeline according to embodiments of the invention;

FIG. 1B is a block diagram illustrating both an exemplary embodiment of an in-order architecture core and an exemplary register renaming, out-of-order issue/execution architecture core to be included in a processor according to embodiments of the invention;

FIG. 2 is a block diagram of a single core processor and a multicore processor with integrated memory controller and graphics according to embodiments of the invention;

FIG. 3 illustrates a block diagram of a system in accordance with one embodiment of the present invention;

FIG. 4 illustrates a block diagram of a second system in accordance with an embodiment of the present invention;

FIG. 5 illustrates a block diagram of a third system in accordance with an embodiment of the present invention;

FIG. 6 illustrates a block diagram of a system on a chip (SoC) in accordance with an embodiment of the present invention;

FIG. 7 illustrates a block diagram contrasting the use of a software instruction converter to convert binary instructions in a source instruction set to binary instructions in a target instruction set according to embodiments of the invention;

FIG. 8 illustrates one embodiment of a method for performing speech recognition that includes a weighted finite state transducer (WFST) component;

FIG. 9 illustrates a flowchart depicting operations performed by one embodiment of a WFST decoder;

FIGS. 10A-C illustrate a set of exemplary token passing processes through different types of arcs of an exemplary WFST graph;

FIG. 11 illustrates a system architecture in accordance with one embodiment of the invention; and

FIG. 12 illustrates a WFST decoder architecture in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Processor Architectures and Data Types

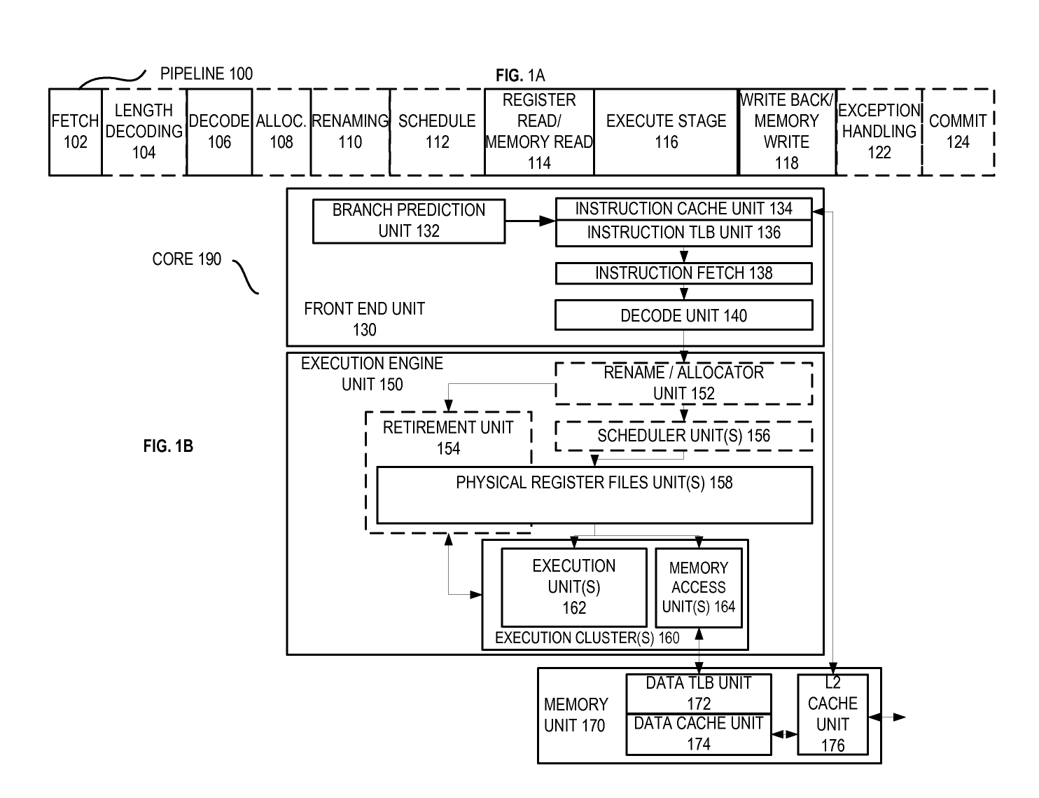

FIG. 1A is a block diagram illustrating both an exemplary in-order pipeline and an exemplary register renaming, out-of-order issue/execution pipeline according to embodiments of the invention. FIG. 1B is a block diagram illustrating both an exemplary embodiment of an in-order architecture core and an exemplary register renaming, out-of-order issue/execution architecture core to be included in a processor according to embodiments of the invention. The solid lined boxes in FIGS. 1A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 1A, a processor pipeline 100 includes a fetch stage 102, a length decode stage 104, a decode stage 106, an allocation stage 108, a renaming stage 110, a scheduling (also known as a dispatch or issue) stage 112, a register read/memory read stage 114, an execute stage 116, a write back/memory write stage 118, an exception handling stage 122, and a commit stage 124.

FIG. 1B shows processor core 190 including a front end unit 130 coupled to an execution engine unit 150, and both are coupled to a memory unit 170. The core 190 may be a reduced instruction set computing (RISC) core, a complex instruction set computing (CISC) core, a very long instruction word (VLIW) core, or a hybrid or alternative core type. As yet another option, the core 190 may be a special-purpose core, such as, for example, a network or communication core, compression engine, coprocessor core, general purpose computing graphics processing unit (GPGPU) core, graphics core, or the like.

The front end unit 130 includes a branch prediction unit 132 coupled to an instruction cache unit 134, which is coupled to an instruction translation lookaside buffer (TLB) 136, which is coupled to an instruction fetch unit 138, which is coupled to a decode unit 140. The decode unit 140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 190 includes a microcode ROM or other medium that stores microcode for certain macroinstructions (e.g., in decode unit 140 or otherwise within the front end unit 130). The decode unit 140 is coupled to a rename/allocator unit 152 in the execution engine unit 150.

The execution engine unit 150 includes the rename/allocator unit 152 coupled to a retirement unit 154 and a set of one or more scheduler unit(s) 156. The scheduler unit(s) 156 represents any number of different schedulers, including reservations stations, central instruction window, etc. The scheduler unit(s) 156 is coupled to the physical register file(s) unit(s) 158. Each of the physical register file(s) units 158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 158 comprises a vector registers unit, a write mask registers unit, and a scalar registers unit. These register units may provide architectural vector registers, vector mask registers, and general purpose registers. The physical register file(s) unit(s) 158 is overlapped by the retirement unit 154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 154 and the physical register file(s) unit(s) 158 are coupled to the execution cluster(s) 160. The execution cluster(s) 160 includes a set of one or more execution units 162 and a set of one or more memory access units 164. The execution units 162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 156, physical register file(s) unit(s) 158, and execution cluster(s) 160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 164). It should also be understood that where separate pipelines are used, one or more of these pipelines may be out-of-order issue/execution and the rest in-order.

The set of memory access units 164 is coupled to the memory unit 170, which includes a data TLB unit 172 coupled to a data cache unit 174 coupled to a level 2 (L2) cache unit 176. In one exemplary embodiment, the memory access units 164 may include a load unit, a store address unit, and a store data unit, each of which is coupled to the data TLB unit 172 in the memory unit 170. The instruction cache unit 134 is further coupled to a level 2 (L2) cache unit 176 in the memory unit 170. The L2 cache unit 176 is coupled to one or more other levels of cache and eventually to a main memory.

By way of example, the exemplary register renaming, out-of-order issue/execution core architecture may implement the pipeline 100 as follows: 1) the instruction fetch 138 performs the fetch and length decoding stages 102 and 104; 2) the decode unit 140 performs the decode stage 106; 3) the rename/allocator unit 152 performs the allocation stage 108 and renaming stage 110; 4) the scheduler unit(s) 156 performs the schedule stage 112; 5) the physical register file(s) unit(s) 158 and the memory unit 170 perform the register read/memory read stage 114; the execution cluster 160 perform the execute stage 116; 6) the memory unit 170 and the physical register file(s) unit(s) 158 perform the write back/memory write stage 118; 7) various units may be involved in the exception handling stage 122; and 8) the retirement unit 154 and the physical register file(s) unit(s) 158 perform the commit stage 124.

The core 190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 190 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 134/174 and a shared L2 cache unit 176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

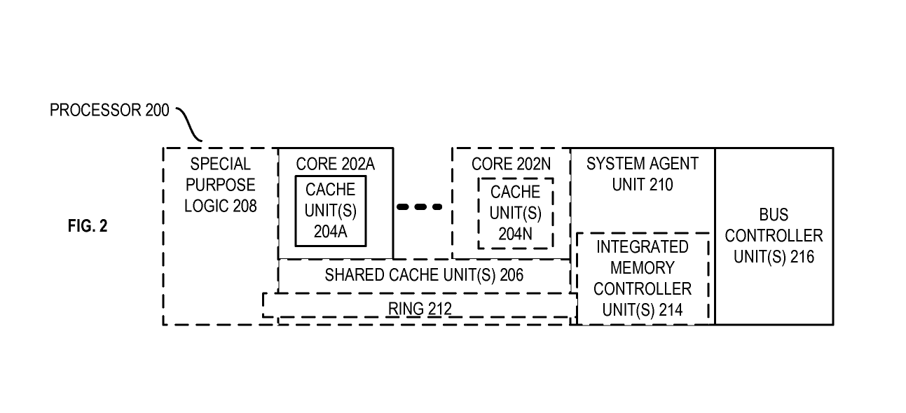

FIG. 2 is a block diagram of a processor 200 that may have more than one core, may have an integrated memory controller, and may have integrated graphics according to embodiments of the invention. The solid lined boxes in FIG. 2 illustrate a processor 200 with a single core 202A, a system agent 210, a set of one or more bus controller units 216, while the optional addition of the dashed lined boxes illustrates an alternative processor 200 with multiple cores 202A-N, a set of one or more integrated memory controller unit(s) 214 in the system agent unit 210, and special purpose logic 208.

Thus, different implementations of the processor 200 may include: 1) a CPU with the special purpose logic 208 being integrated graphics and/or scientific (throughput) logic (which may include one or more cores), and the cores 202A-N being one or more general purpose cores (e.g., general purpose in-order cores, general purpose out-of-order cores, a combination of the two); 2) a coprocessor with the cores 202A-N being a large number of special purpose cores intended primarily for graphics and/or scientific (throughput); and 3) a coprocessor with the cores 202A-N being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 206, and external memory (not shown) coupled to the set of integrated memory controller units 214. The set of shared cache units 206 may include one or more mid-level caches, such as level 2 (L2), level 3 (L3), level 4 (L4), or other levels of cache, a last level cache (LLC), and/or combinations thereof. While in one embodiment a ring based interconnect unit 212 interconnects the integrated graphics logic 208, the set of shared cache units 206, and the system agent unit 210/integrated memory controller unit(s) 214, alternative embodiments may use any number of well-known techniques for interconnecting such units. In one embodiment, coherency is maintained between one or more cache units 206 and cores 202-A-N.

In some embodiments, one or more of the cores 202A-N are capable of multi-threading. The system agent 210 includes those components coordinating and operating cores 202A-N. The system agent unit 210 may include for example a power control unit (PCU) and a display unit. The PCU may be or include logic and components needed for regulating the power state of the cores 202A-N and the integrated graphics logic 208. The display unit is for driving one or more externally connected displays.

The cores 202A-N may be homogenous or heterogeneous in terms of architecture instruction set; that is, two or more of the cores 202A-N may be capable of execution the same instruction set, while others may be capable of executing only a subset of that instruction set or a different instruction set. In one embodiment, the cores 202A-N are heterogeneous and include both the “small” cores and “big” cores described below.

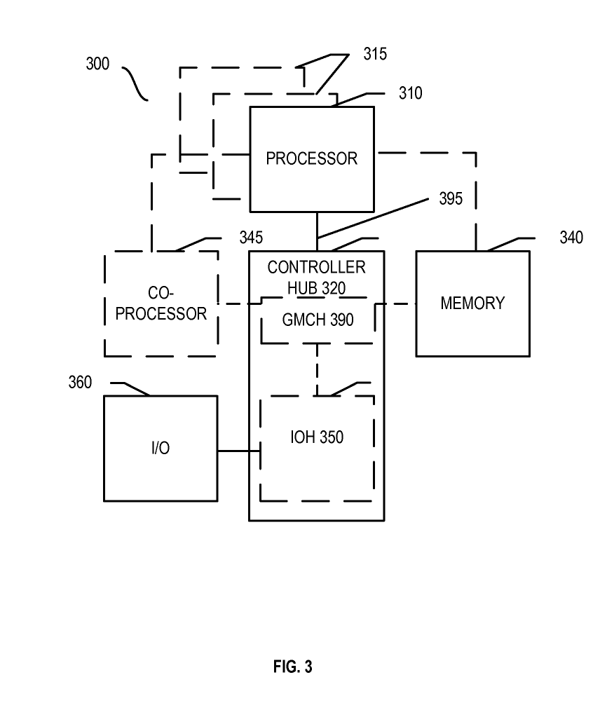

FIGS. 3-6 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 3, shown is a block diagram of a system 300 in accordance with one embodiment of the present invention. The system 300 may include one or more processors 310, 315, which are coupled to a controller hub 320. In one embodiment the controller hub 320 includes a graphics memory controller hub (GMCH) 390 and an Input/Output Hub (IOH) 350 (which may be on separate chips); the GMCH 390 includes memory and graphics controllers to which are coupled memory 340 and a coprocessor 345; the IOH 350 is couples input/output (I/O) devices 360 to the GMCH 390. Alternatively, one or both of the memory and graphics controllers are integrated within the processor (as described herein), the memory 340 and the coprocessor 345 are coupled directly to the processor 310, and the controller hub 320 in a single chip with the IOH 350.

The optional nature of additional processors 315 is denoted in FIG. 3 with broken lines. Each processor 310, 315 may include one or more of the processing cores described herein and may be some version of the processor 200.

The memory 340 may be, for example, dynamic random access memory (DRAM), phase change memory (PCM), or a combination of the two. For at least one embodiment, the controller hub 320 communicates with the processor(s) 310, 315 via a multi-drop bus, such as a frontside bus (FSB), point-to-point interface such as QuickPath Interconnect (QPI), or similar connection 395.

In one embodiment, the coprocessor 345 is a special-purpose processor, such as, for example, a high-throughput MIC processor, a network or communication processor, compression engine, graphics processor, GPGPU, embedded processor, or the like. In one embodiment, controller hub 320 may include an integrated graphics accelerator.

There can be a variety of differences between the physical resources 310, 315 in terms of a spectrum of metrics of merit including architectural, microarchitectural, thermal, power consumption characteristics, and the like.

In one embodiment, the processor 310 executes instructions that control data processing operations of a general type. Embedded within the instructions may be coprocessor instructions. The processor 310 recognizes these coprocessor instructions as being of a type that should be executed by the attached coprocessor 345. Accordingly, the processor 310 issues these coprocessor instructions (or control signals representing coprocessor instructions) on a coprocessor bus or other interconnect, to coprocessor 345. Coprocessor(s) 345 accept and execute the received coprocessor instructions.

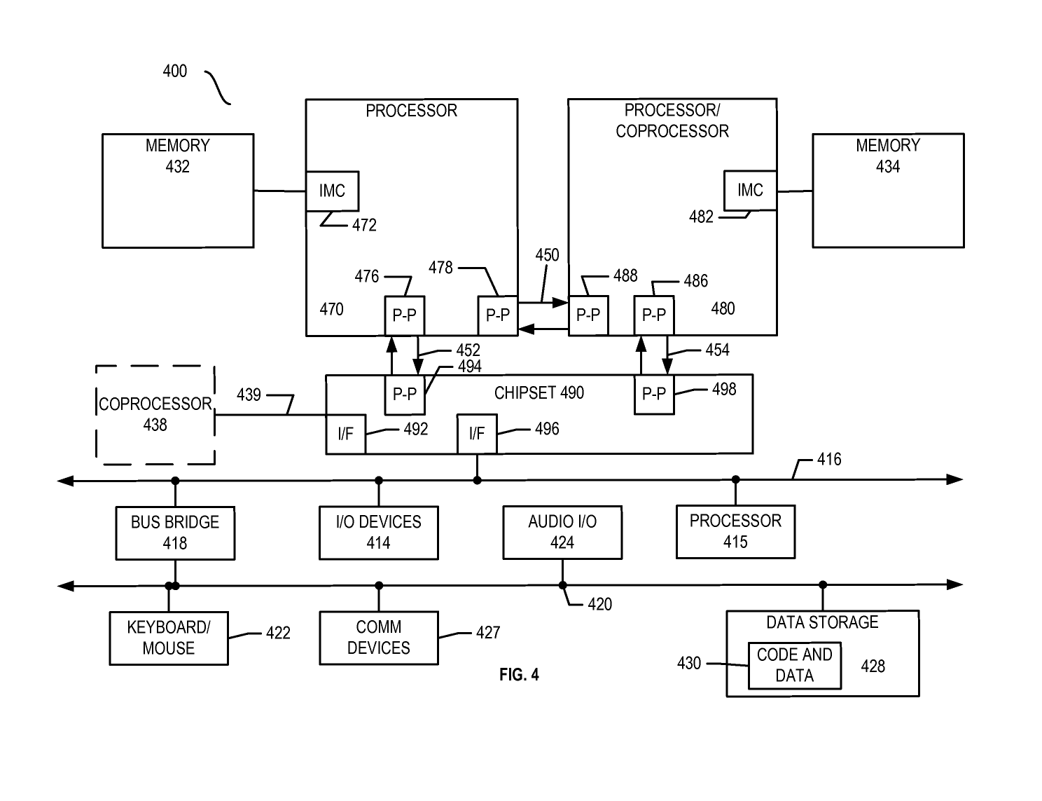

Referring now to FIG. 4, shown is a block diagram of a first more specific exemplary system 400 in accordance with an embodiment of the present invention. As shown in FIG. 4, multiprocessor system 400 is a point-to-point interconnect system, and includes a first processor 470 and a second processor 480 coupled via a point-to-point interconnect 450. Each of processors 470 and 480 may be some version of the processor 200. In one embodiment of the invention, processors 470 and 480 are respectively processors 310 and 315, while coprocessor 438 is coprocessor 345. In another embodiment, processors 470 and 480 are respectively processor 310 coprocessor 345.

Processors 470 and 480 are shown including integrated memory controller (IMC) units 472 and 482, respectively. Processor 470 also includes as part of its bus controller units point-to-point (P-P) interfaces 476 and 478; similarly, second processor 480 includes P-P interfaces 486 and 488. Processors 470, 480 may exchange information via a point-to-point (P-P) interface 450 using P-P interface circuits 478, 488. As shown in FIG. 4, IMCs 472 and 482 couple the processors to respective memories, namely a memory 432 and a memory 434, which may be portions of main memory locally attached to the respective processors.

Processors 470, 480 may each exchange information with a chipset 490 via individual P-P interfaces 452, 454 using point to point interface circuits 476, 494, 486, 498. Chipset 490 may optionally exchange information with the coprocessor 438 via a high-performance interface 439. In one embodiment, the coprocessor 438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 490 may be coupled to a first bus 416 via an interface 496. In one embodiment, first bus 416 may be a Peripheral Component Interconnect (PCI) bus, or a bus such as a PCI Express bus or another third generation I/O interconnect bus, although the scope of the present invention is not so limited.

As shown in FIG. 4, various I/O devices 414 may be coupled to first bus 416, along with a bus bridge 418 which couples first bus 416 to a second bus 420. In one embodiment, one or more additional processor(s) 415, such as coprocessors, high-throughput MIC processors, GPGPU's, accelerators (such as, e.g., graphics accelerators or digital signal processing (DSP) units), field programmable gate arrays, or any other processor, are coupled to first bus 416. In one embodiment, second bus 420 may be a low pin count (LPC) bus. Various devices may be coupled to a second bus 420 including, for example, a keyboard and/or mouse 422, communication devices 427 and a storage unit 428 such as a disk drive or other mass storage device which may include instructions/code and data 430, in one embodiment. Further, an audio I/O 424 may be coupled to the second bus 420. Note that other architectures are possible. For example, instead of the point-to-point architecture of FIG. 4, a system may implement a multi-drop bus or other such architecture.

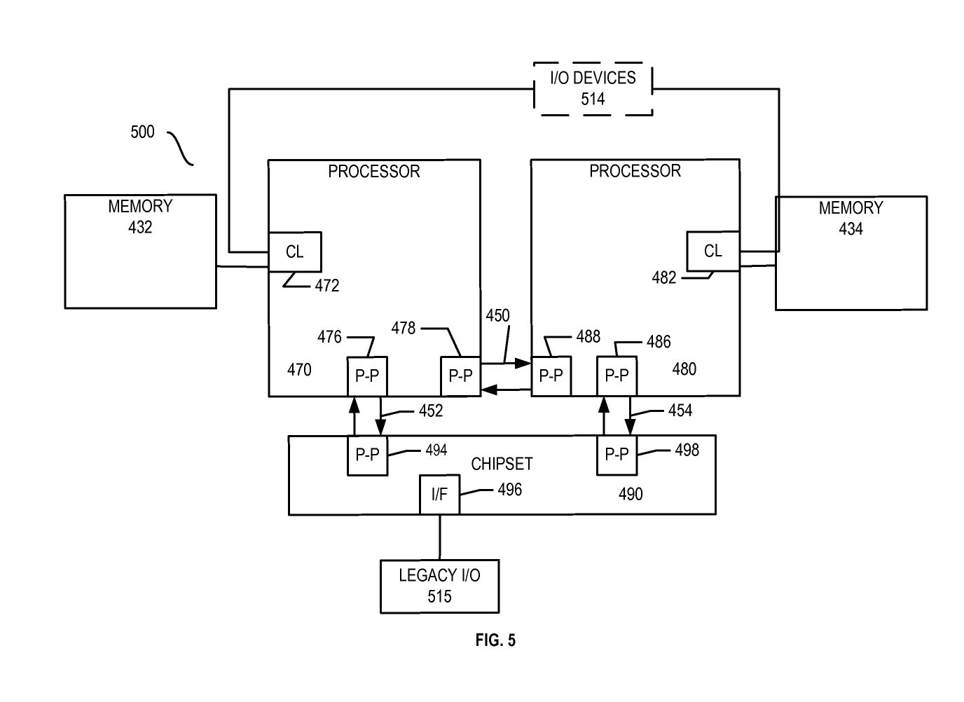

Referring now to FIG. 5, shown is a block diagram of a second more specific exemplary system 500 in accordance with an embodiment of the present invention. Like elements in FIGS. 4 and 5 bear like reference numerals, and certain aspects of FIG. 4 have been omitted from FIG. 5 in order to avoid obscuring other aspects of FIG. 5.

FIG. 5 illustrates that the processors 470, 480 may include integrated memory and I/O control logic (“CL”) 472 and 482, respectively. Thus, the CL 472, 482 include integrated memory controller units and include I/O control logic. FIG. 5 illustrates that not only are the memories 432, 434 coupled to the CL 472, 482, but also that I/O devices 514 are also coupled to the control logic 472, 482. Legacy I/O devices 515 are coupled to the chipset 490.

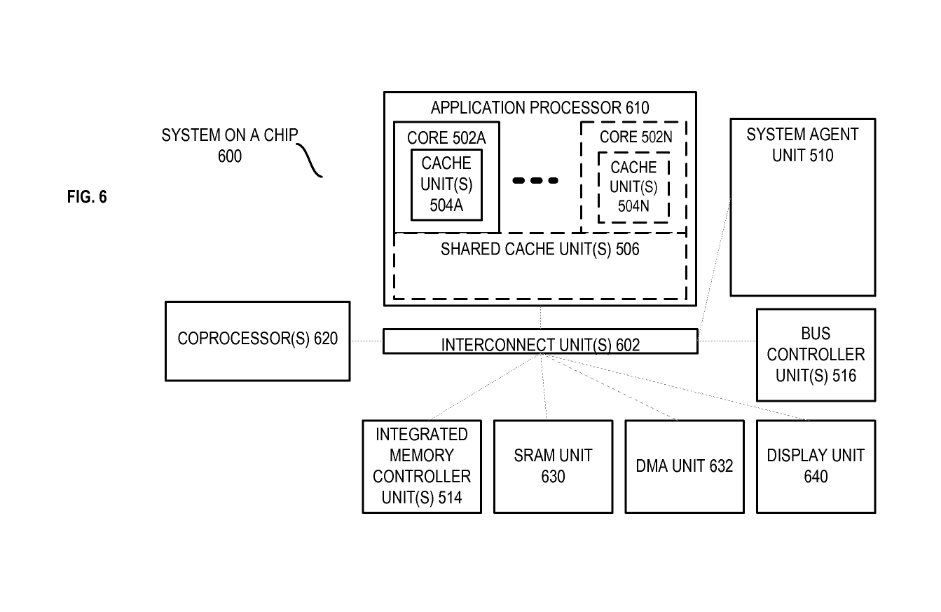

Referring now to FIG. 6, shown is a block diagram of a SoC 600 in accordance with an embodiment of the present invention. Similar elements in FIG. 2 bear like reference numerals. Also, dashed lined boxes are optional features on more advanced SoCs. In FIG. 6, an interconnect unit(s) 602 is coupled to: an application processor 610 which includes a set of one or more cores 202A-N and shared cache unit(s) 206; a system agent unit 210; a bus controller unit(s) 216; an integrated memory controller unit(s) 214; a set or one or more coprocessors 620 which may include integrated graphics logic, an image processor, an audio processor, and a video processor; an static random access memory (SRAM) unit 630; a direct memory access (DMA) unit 632; and a display unit 640 for coupling to one or more external displays. In one embodiment, the coprocessor(s) 620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 430 illustrated in FIG. 4, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

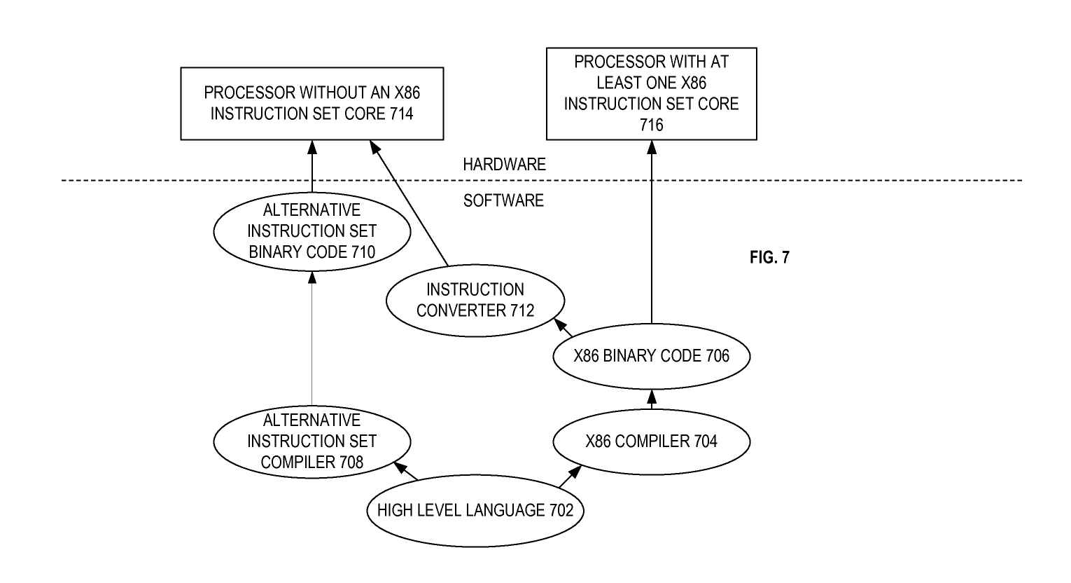

FIG. 7 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 7 shows a program in a high level language 702 may be compiled using an x86 compiler 704 to generate x86 binary code 706 that may be natively executed by a processor with at least one x86 instruction set core 716. The processor with at least one x86 instruction set core 716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 704 represents a compiler that is operable to generate x86 binary code 706 (e.g., object code) that can, with or without additional linkage processing, be executed on the processor with at least one x86 instruction set core 716. Similarly, FIG. 7 shows the program in the high level language 702 may be compiled using an alternative instruction set compiler 708 to generate alternative instruction set binary code 710 that may be natively executed by a processor without at least one x86 instruction set core 714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 712 is used to convert the x86 binary code 706 into code that may be natively executed by the processor without an x86 instruction set core 714. This converted code is not likely to be the same as the alternative instruction set binary code 710 because an instruction converter capable of this is difficult to make; however, the converted code will accomplish the general operation and be made up of instructions from the alternative instruction set. Thus, the instruction converter 712 represents software, firmware, hardware, or a combination thereof that, through emulation, simulation or any other process, allows a processor or other electronic device that does not have an x86 instruction set processor or core to execute the x86 binary code 706.

### Apparatus and Method for Efficient, Low Power Finite State Transducer Decoding

Speech recognition technology is the safest way to enter text while driving and the most efficient way to enter text on devices without keyboards. In meeting the need for speech input on mobile computing platforms, it is desirable to have accuracy, latency, and power consumption no worse than that of a keyboard.

The embodiments of the invention described below divide speech recognition computation into components in a manner that enables long, high accuracy speech recognition sessions with minimal battery life impact. One embodiment also provides a system-wide weighted finite state transducer (WFST) decoding block that can be leveraged in many other high-intensity text processing applications.

In one embodiment, the speech recognition workload is divided among the processor (CPU or DSP), a Gaussian Mixture Model (GMM) scoring accelerator (e.g., such as the GMM scoring accelerator designed by the assignee of the present application), and special purpose WFST decoding hardware (described in detail below). In one embodiment of the invention, feature extraction, feature compensation, GMM score handling, and WFST back-trace are performed on the CPU and/or a DSP (less than 4% of total processing time today). Acoustic model likelihoods are computed, for example, using GMM scoring acceleration hardware (approximately 48% of total processing time today). Speech decoding is performed using low-power special-purpose WFST decoding hardware (around 48% of total processing time today). Consequently, using the embodiments of the invention, approximately 96% of processing that normally occurs on the CPU/DSP is offloaded to very low power special purpose silicon. Therefore, the CPU/DSP can potentially spend the vast majority of time during speech recognition in a low power state.

Today, the speech decoding portion of speech recognition is run entirely on the CPU. With GMM scoring acceleration technology, about half of speech recognition processing can be offloaded to low power hardware. The embodiments of the invention introduce special purpose WFST hardware that offloads most of the remaining processing. The result is uncompromised speech recognition processing that uses a very small fraction of one CPU core (as opposed to multiple cores) and a very small fraction of the energy of today's implementations.

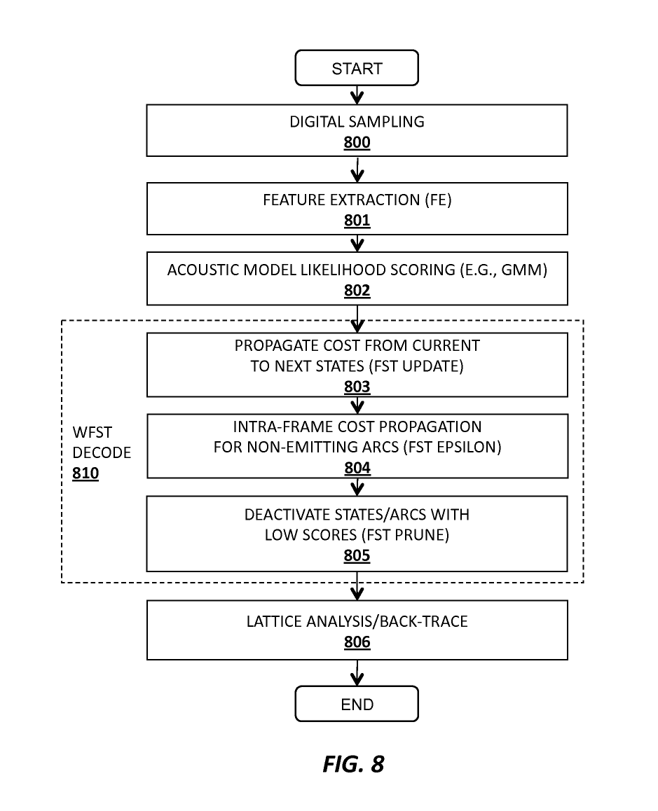

FIG. 8 provides an overview of the speech recognition process employed in one embodiment of the invention. At the digital sampling stage, an acoustic pressure wave from the user's voice is sensed by a microphone which converts the pressure wave into a time-varying voltage. An analog to digital (A/D) converter samples the voltage at a specified sampling frequency such as, for example, 16,000 times a second. The output is a stream of 16,000 digital samples transmitted over the bus. In one embodiment, the samples are grouped into “frames” of 32 ms of speech. A new frame may be captured every 10 ms resulting in 32 ms partially overlapping frames offset by 10 ms increments.

At 801 feature extraction (FE) is performed on the incoming frames. The goal of feature extraction is to preserve the information-bearing portion of the signal while discarding anything that is redundant or unnecessary for recognition. In practice, it involves extracting the spectral envelope of the signal. Feature extraction is well understood in the art and all of the details will not be provided here to avoid obscuring the underlying principles of the invention. In one embodiment, the feature extraction operation takes in 256 samples and outputs a vector sequence of 13 samples representing features of the 32 ms frame relevant for speech recognition. The feature extraction operation then takes first and second derivatives of this vector sequence to arrive at 39 coefficients, which may be padded to 40. The end result is a feature vector comprising 40 dimensional vectors representing the sound at this particular 10 ms offset into the signal (using a 32 ms window). The feature vector represents a snapshot in time of the vocal tract.

At 802, acoustic model likelihood scoring compares the feature vector against a library of models of known speech sounds that have been compiled with training data. In the case of GMM, the likelihood of a particular sound from the 32 ms frame matching a known speech sound is calculated in 40 dimensions (i.e., one for each of the 40 dimensional vectors). For every sound in the library a score is produced. Thus, if the library includes 10,000 different sounds, the input of each feature vector produces an output of 10,000 scores, each score comprising a number representing the similarity between the feature vector and the sound in the library. For example, the score may be a value between 0 and 1. Alternatively, the score may be based on a log probability and have a value between 0 and a negative number. Regardless of how the feature vector is scored, at this stage, there is a mapping from the audio signal to the stored acoustic models.

In one embodiment of the invention, the next three stages 803-805 of the speech recognition process are implemented by the WFST decode block 810. In one embodiment, the WFST is a Mealy finite state machine whose output values are determined both by its current state and the current inputs (e.g., the GMM likelihood scores). The finite state machine defines 1) acceptable input sequences and 2) their corresponding output sequences and weights. It is represented by a graph structure with states and arcs. Each arc has five attributes: source state, destination state, input symbol, output symbol and weight.

Since WFST assigns probability for each transduction from a sequence of inputs to a sequence of outputs, it can be utilized to define any probabilistic transduction. For instance, the speech recognition is a transduction process from a sequence of acoustic scores computed from the input speech to a sequence of words. A WFST that defines the transduction from a sequence of English words to a sequence of Chinese words can be used for statistical machine translation.

WFSTs can be cascaded to perform multi-level probabilistic transductions. Most of the speech recognition algorithms utilize multiple transductions such as acoustic model to sub-phonetic pronunciation unit, pronunciation to word, and so on. Each of the transduction process can be represented by WFSTs and be cascaded to perform the recognition.

In the cascaded WFSTs, output sequences of the preceding WFST is used as input sequences of the following WFST. Those WFSTs can be unified into one single WFST by the composition algorithm that defines the direct transduction from the input sequences of the preceding WFST to the output sequences of the following WFST. Thanks to the composition, the applications in the WFST framework may process one single WFST to perform multi-level probabilistic transduction, which make the recognition process simple and uniform. In addition dynamic composition enables cascading of WFST on-the-fly (e.g., not generating all the output of the first WFST before the operation of the second WFST), yielding improved results.

Returning to FIG. 8, in one embodiment, the likelihoods generated by the acoustic model likelihood scoring operations 802 are mapped onto hidden multi-layered Markov model (HMM) states where the layers have been constructed according to acoustic, lexical, and language models. Specifically, at stage 803, there is a state representation of the current speech which is used by the Viterbi algorithm to traverse the graph. At 803, the active states and arcs are fetched and Viterbi algorithm is applied to update the states/arcs (i.e., to determine scores associated with each path through the graph). In addition, pruning thresholds may also be calculated. At 804, intra-frame cost propagation for non-emitting acrs is determined and updates are applied to current states/arcs. In particular, the state can advance without any new GMM scores (sometimes referred to herein as “input labels”). Thus, at 804, the Viterbi process continues to advance through the graph as long as a new likelihood score is not required to proceed. Finally, at 805, states/arcs with low likelihood scores are pruned. That is, if a particular path through the graph has a score below a specified threshold, it will be removed due to its low likelihood. The end result is a lattice comprising the paths through the graph having the greatest likelihood.

Finally, at 806, the results for the speech frame are constructed by performing a back-trace through the lattice and generating data representing the chosen paths which may then be used as input for subsequent processing.

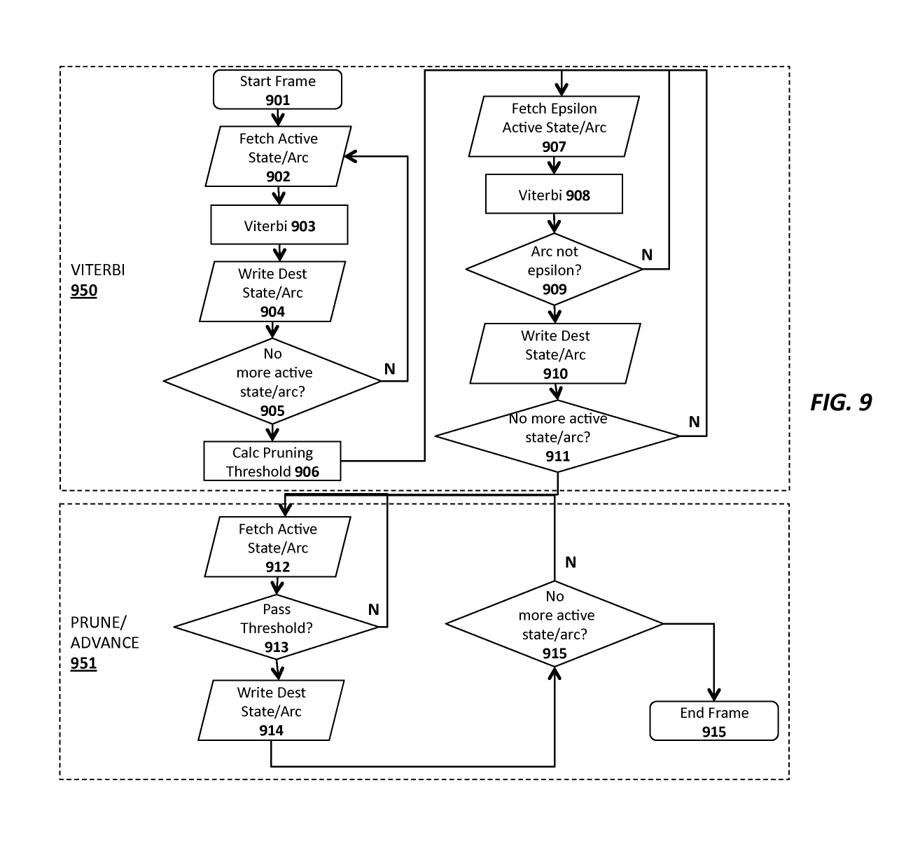

FIG. 9 provides additional details associated with the WFST decode block 810 which is logically subdivided into a Viterbi portion 950 and a prune/advance portion 951. Mapping FIG. 9 to FIG. 8, operations 901-906 correspond generally to block 803, operations 907-911 correspond to block 804, and operations 912-915 correspond to block 805.

In response to a new frame at 901, the current active state/arc is fetched at 902, and Viterbi is applied at 903 which involves a series of add/compare/select operations. In particular, the arc weight and input label score (e.g., GMM score) is added, the score for that path is updated, and the results are written back out at 904. When there are no more active states/arcs, determined at 905, the current pruning threshold is re-calculated at 906. In one embodiment, the pruning threshold may depend on the average score or the minimum score of all of the states that have been seen so far. The ultimate goal is to retain those N paths with the greatest likelihood. For example, the WFST decoder may choose to retain the paths with the highest 20 scores and determine the threshold that results in 20.

Operations 907-911 are performed for epsilon arcs. As mentioned above, the state of the system can advance without any new input labels (GMM scores). Thus, at 907, the epsilon active state/arc is fetched, Viterbi is performed at 908, and the process repeats until a new input label is needed, determined at 909. At 910 the results are written back out and if no more active states/arcs exist, determined at 911, then the pruning process is initiated. Specifically, at 912, the active state/arc is fetched and if it does not pass the threshold, determined at 913, then it is discarded and the next active state/arc is fetched at 912. If an active state/arc passes the threshold at 913, then it is written out at 914. This process continues until no more active arcs/states exist, determined at 915, representing the end of the current frame 915.

One embodiment of the invention uses four knowledge sources to perform speech recognition: 1) Acoustic features to sub-phonetic HMMs, 2) HMMs to tri-phones, 3) Tri-phones to word and 4) Words to sentences. Each of the knowledge sources are statistical probabilistic transduction processes and can be represented by four WFSTs:
H: HMM acoustic model
C: Context dependency model (e.g., tri-phone definitions)
L: Lexicon (pronunciation dictionary)
G: Grammar (language model)

In one embodiment, these four graphical models can be composed into single model of speech H∘C∘L∘G and searched using the Viterbi algorithm using the techniques described herein. This search model is somewhat simpler than models found in conventional HMM-based speech decoders.

Given the WFST graph (H∘C∘L∘G), speech recognition can be performed by Viterbi search over the graph. Acoustic front-end processing for feature extraction and acoustic model scoring is described above. The following discussion focuses on the search algorithm assuming that the acoustic model scores are computed from either a GMM Scoring Accelerator or any generic software and fed into the search algorithm.

In one embodiment, a token passing algorithm is used to perform the Viterbi search over the WFST graph by passing tokens between states. Each token contains the likelihood of the path that the token has been gone through and the back pointer that can be used to trace back the path. In one embodiment, the token passing algorithm over a single WFST graph contains the following operations, which are repeated for every speech frame to be processed:

1. Get active input label list

2. Get input label scores

3. Token passing through non-epsilon arcs

4. Token passing through epsilon arcs

5. Beam Pruning (optional)

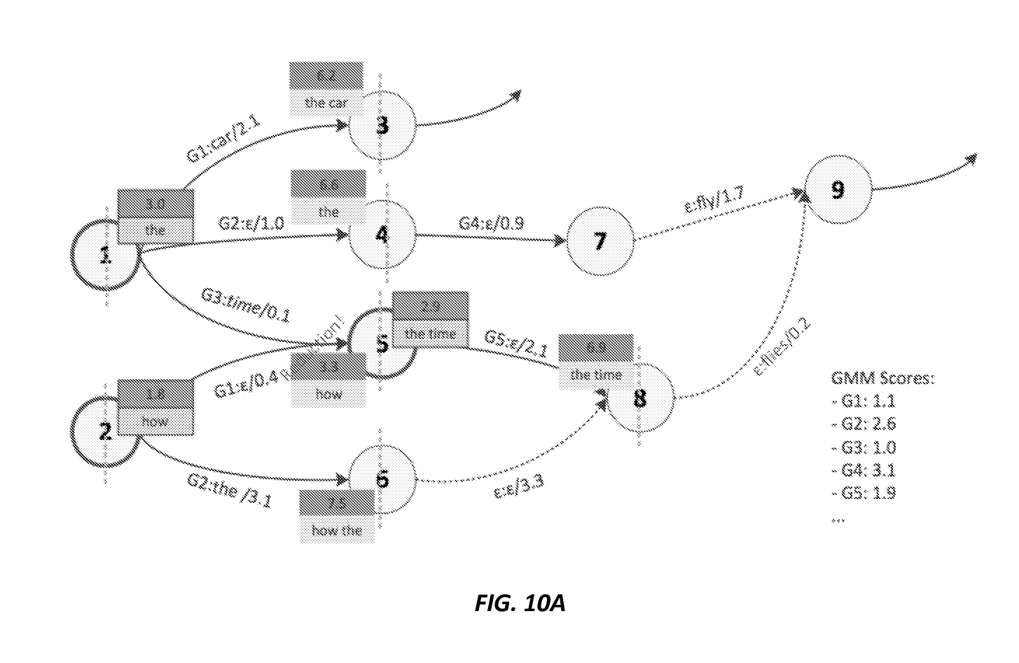

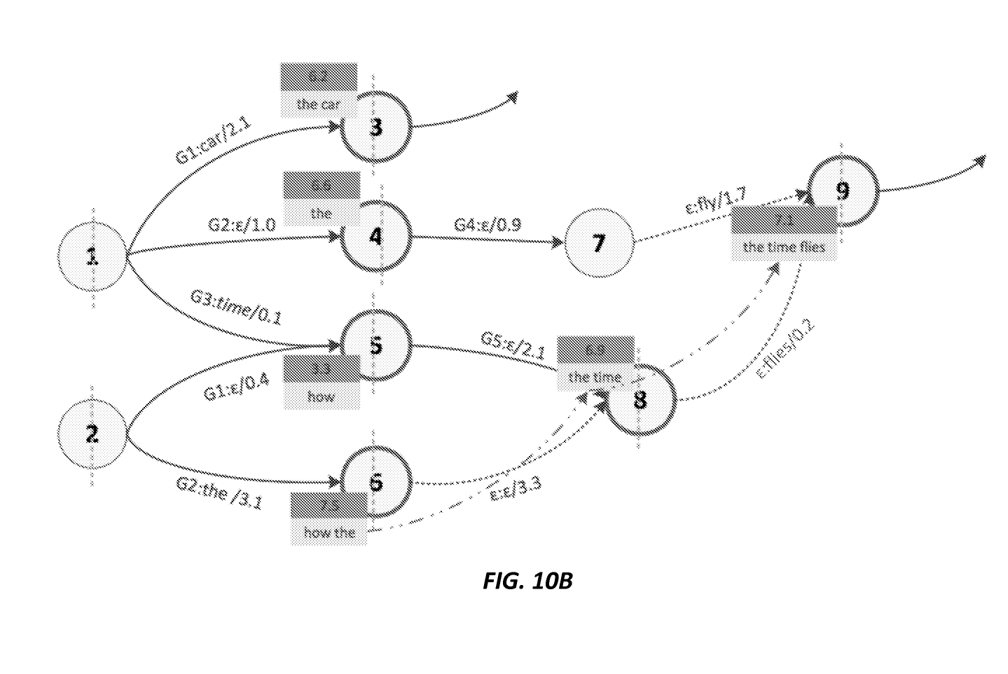

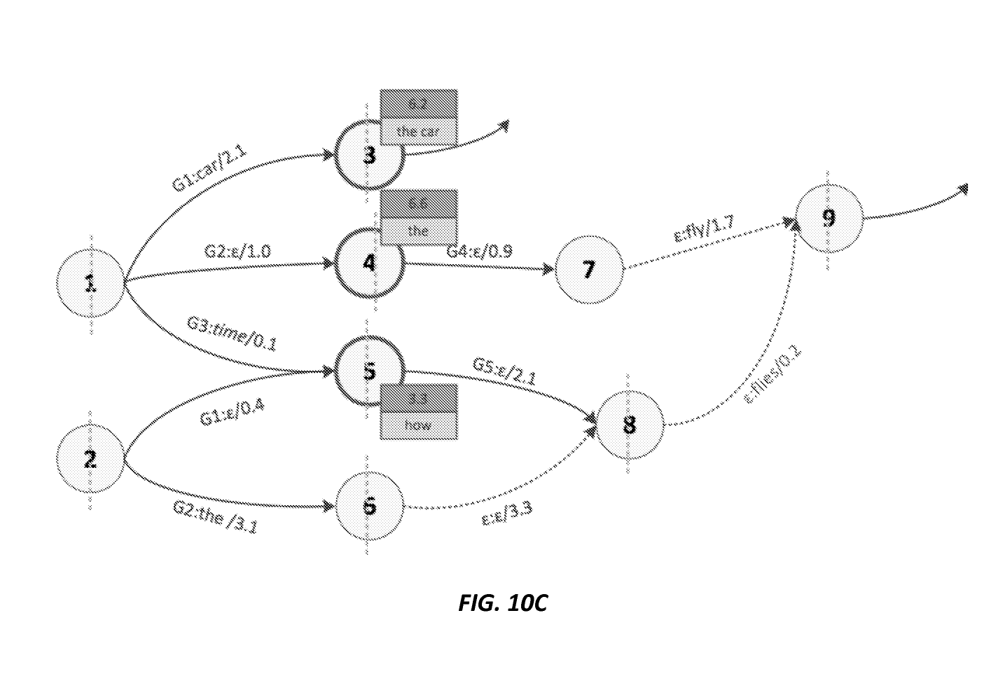

Operations (1) and (2) are aimed at retrieving the input label scores (e.g. GMM scores) needed for the token passing procedure. The differences between operations (3) and (4) are the type of arcs through which the token passing is performed. As mentioned above, non-epsilon arcs have an input label (e.g. GMM identifier), and each token passing through the non-epsilon arc consumes one input label score. Since each input label represents an acoustic model and its score has been computed for the current speech frame, one embodiment of the algorithm proceeds at most one non-epsilon arc per frame. FIG. 10A shows an exemplary token passing procedure through non-epsilon arcs of an exemplary WFST graph.

In FIG. 10A, the states 1, 2, and 5 have an active token to propagate. Through operations (1) and (2) the list of GMMs that need to be scored are collected ({G1, G2, G3, G5}) and their GMM scores are computed. During the token passing through non-epsilon arcs procedure, the tokens are updated with input label scores (e.g., GMM scores), output labels, and the weights of the non-epsilon arcs. The token in state 1 is propagated to the states 3, 4, 5 and the token in state 2 is propagated to the states 5 and 6. For example, the state 3 will receive the token from the state 1 with the cost updated by the input label score and the arc weight (6.2=3.0+1.1(G1)+2.1 (arc weight), log summing, cost are being added up) and the back pointer updated by the output label ({the} to {the car}).

In the case that a destination state receives more than a single token from multiple source states as shown in state 5 of the example, the Viterbi algorithm chooses the best token (i.e. the one with the lowest cost). For example, the token from state 1 to state 5 will have the cost of 4.1 while the token from the state 2 will have the cost of 3.3. Consequently, the token from the state 2 is chosen for the incoming token for the state 5. As mentioned above, in one embodiment, an N-best token passing algorithm retains N tokens to track more than one path.

In one embodiment, when there are more than two tokens merging into the same destination states with the exact same cost, a tie-breaking rule is implemented to avoid non-deterministic behavior of the algorithm when implemented in the parallel platforms. If multiple execution units (EUs) try to update the destination state within a frame and their tokens have the same cost but different word histories, the token chosen in the destination would be different by the timing of the destination updated by multiple EUs.

Token processing through epsilon arcs is similar to the token processing through non-epsilon arcs, but there is a fundamental difference because the arcs do not have an input label (i.e., epsilon input label). Since the propagation through epsilon arcs does not consume any input label scores, the propagation can continue through consecutive epsilon arcs within a frame. In fact, the epsilon represents the relation between states meaning in that if one state is updated, all the states connected through the epsilon arc should be updated with the relational changes in cost and back pointer.

FIG. 10B illustrates the token passing through epsilon arcs. In this example, states 6 and 8 have been updated during the token passing through non-epsilon arcs procedure (FIG. 10A). Since there are epsilon arcs connecting the state 6, 8 and 9, the token in the state 6 and state 8 should be updated through the epsilon arcs. The token in the state 8 has lower cost than the token in state 6 and thus it is used to update state 9. If the cost of the token in state 6 had been lower, both states 8 and 9 would have been updated by the token.

After operations (3) and (4) are completed (all non-epsilon and epsilon arcs are processed), beam pruning may be applied to remove the tokens with highest cost that are unlikely become the best path. There are multiple ways that beam pruning may be performed. In one embodiment, a beam width is set that defines the allowed margin (i.e. a beam threshold) of the survival token cost from the best cost. Once the token passing is complete, the decoder finds the best token that has minimal cost compared with all of the other tokens. The tokens with a cost worse than the best cost plus the beam width may be discarded.

In FIG. 10C, there are six tokens (in-tokens) that were propagated to the states and the best token is the one in state 5 with the cost value of 3.3. If the beam width is set to 3.5, any tokens with cost worse than 6.8 (=3.3+3.5) are discarded during the beam pruning. As a result, the tokens in state 6, 8, and 9 are all removed/pruned and only the tokens in states 3, 4, and 5 remain active. The active tokens after the beam pruning (out-tokens) will be the used for the token propagation in the next frame.

Since this method only prunes out the tokens with high cost, it does not limit the number of active tokens, and theoretically, the number of active tokens can become equal to the number of states. To maintain the number of active tokens to a manageable range, an adaptive beam width method may be applied. For example, a heuristic can be applied to adjust the beam width based on the number of current active tokens (see, e.g., operation 906 in FIG. 9).

There are also other alternatives in the beam pruning methods. For example, the rank of the cost among the active tokens can be used for pruning. In this case, a limited number of tokens are used every frame (e.g., the top 100 tokens), but this may induce overhead to identify the “top” tokens.

Another way to perform beam pruning is to use an estimated beam threshold. The original beam pruning needs the completion of operations (3) and (4) to find the best cost that is used to calculate the beam threshold. However, if the beam threshold is estimated before operations (3) and (4), the estimated threshold can be used to not perform the token passing in the first place. If the beam threshold of 6.8 is estimated, for example, the token will not be passed from state 2 to state 6 and state 5 to state 8. This technique eliminates the necessity of the explicit beam pruning stage, and also reduces a significant amount of token passing operations that would not have been necessary due to pruning.

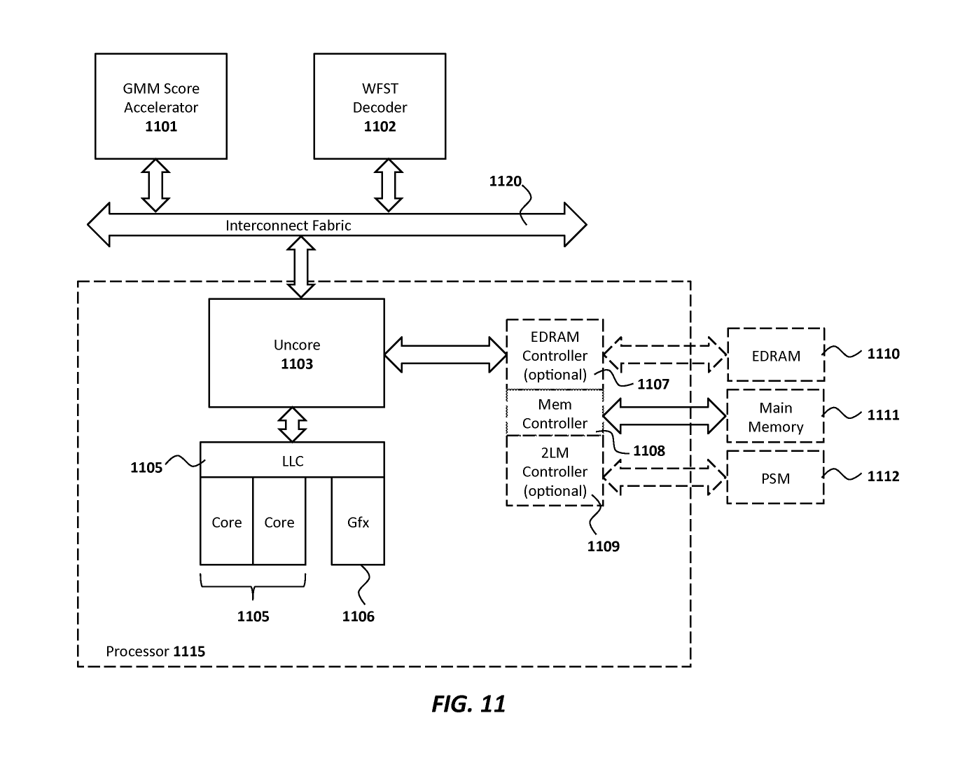

FIG. 11 illustrates one embodiment of a system architecture in which the GMM score accelerator 1101, WFST decoder 1102, and processor 1115 are interconnected on a system fabric 1120 to perform the speech decoding functions described herein. In particular, in one embodiment, the digital sampling and feature extraction operations 800-801 and the lattice analysis/back-trace operations 806 are performed by the processor 1115, the acoustic model likelihood scoring 802 is performed by the GMM score accelerator 1101, and the WFST decode operations 803-805 (see also FIGS. 9, 10A-C and associated text) are performed by the WFST decoder 1102.

In one embodiment, the communication fabric 1120 is the Intel On-Chip System Fabric (IOSF) which is a scalable fabric that supports multicore operation and maintains the PCI-bus order. The processor 1115 is interconnected to the fabric 1120 via an uncore component 1103 which, in one embodiment, manages memory requests and intercommunication with the GMM score accelerator 1101 and WFST decoder 1102. Both the WFST decoder 1102 and GMM score accelerator 1101 include interfaces to couple these devices to the communication fabric 1120 (e.g., using compatible signaling and communication protocols) to enable communication between all of the components on the fabric.

In addition, the exemplary processor shown in FIG. 11 includes a plurality of cores 1104, an integrated graphics unit 1106 and a shared lowest-level cache 1105. Although not shown in the figure, each core 1104 may be configured with additional caches (e.g., mid-level caches (e.g., L2 caches) and upper level caches (e.g., L1 caches)). A memory controller 1108 couples the processor 1115 to main memory 1111 which may be dynamic random access memory (DRAM). Optionally, an embedded DRAM controller 1107 may couple the processor cores 1104 and graphics processing unit 1106 to embedded DRAM 1110 (i.e., DRAM which is embedded on the same silicon die as the processor). An additional optional memory subsystem includes a two-level memory (2LM) controller 1109 coupling the processor to a persistent memory or persistent storage manager (PSM). In one embodiment, the persistent memory is implemented as Phase Change Memory and Switch (PCMS). However, it should be noted that the underlying principles of the invention are not limited to any particular memory or system architecture.

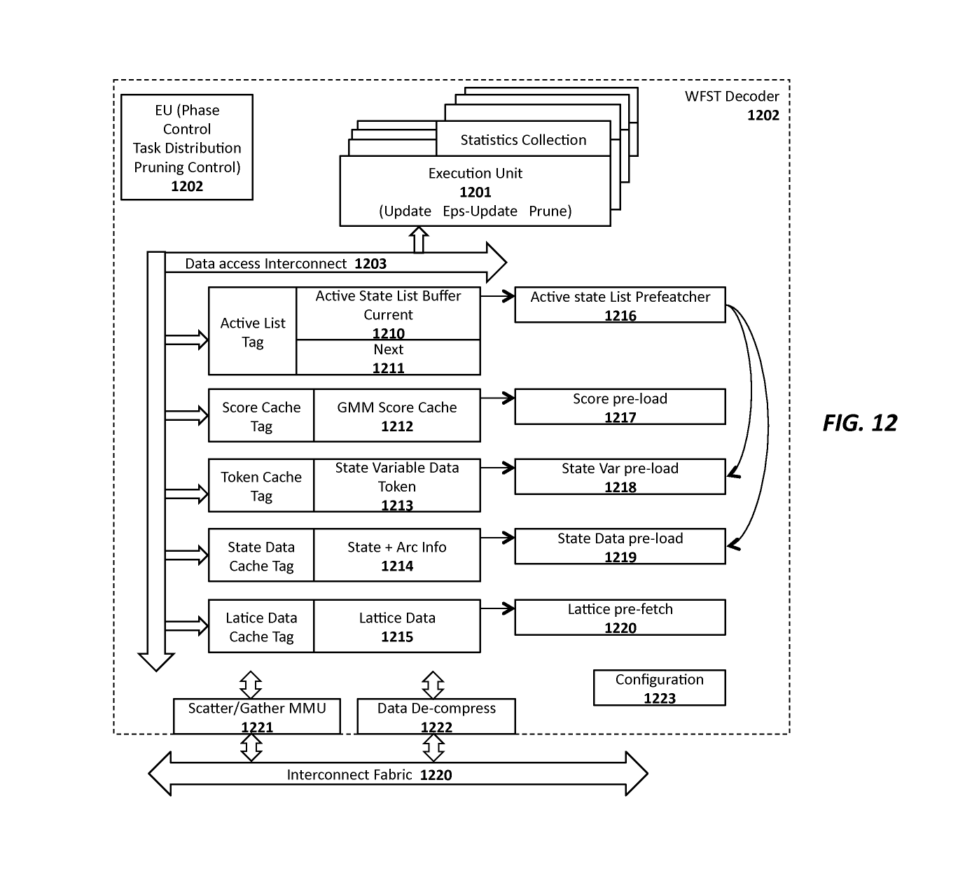

FIG. 12 provides additional details of one embodiment of the WFST decoder 1102 which includes an array of execution units (EUs) 1201. One of the EUs may be programmed to operate as a central controller 1202, dispatching tasks to be executed in parallel by the other EUs 1201. These tasks may include, for example, task distribution, phase control, and pruning control. In one embodiment, the execution units are scalar processor cores running in parallel, streaming in portions of the WFST graph and other data they need, and streaming out the updated scores and associated data. Although 4 EUs are illustrated, the design is scalable so there may be 8, 16, 32, or any number of EUs. The EU acting as the central controller 1202 may retrieve a sequence of instructions from an instruction cache (not shown) to perform its sequence of operations and coordinate the data processing tasks performed by the other EUs 1201.

In one embodiment, an internal data interconnect 1203 couples the EUs 1201-1202 to one or more cache memories 1210-1215 for caching data required to perform the WFST decode operations. In particular, in one embodiment, the data includes the current 1210 and next 1211 active state lists containing the current and next active states for each audio frame (i.e., those which have not been pruned away); the acoustic model likelihood scores (e.g., GMM scores) 1212; the tokens 1213 containing the likelihood of the path that the token has traversed and the back pointer that can be used to trace back the path; the state and arc information (i.e., the WFST graph); and the lattice data comprising the output generated as a result of processing of each audio frame.

In one embodiment, the current active state list 1210 is the entity which is updated in the flowchart shown in FIG. 9. The list is loaded and states are assigned to the EUs 1201 (e.g., each EU processes a portion of the entire list). As each EU works through their state lists as shown in the flowchart, the acoustic model likelihood scores and other data are retrieved from the various caches 1212-1215 as needed. The next state list 1211 is written to in accordance with the flowchart in FIG. 9 as states/arcs are pruned away (and those which are not pruned are written). Once processing of the current audio frame is complete, the next active state list 1211 becomes the current active state list 1210.

The lattice data 1215 comprises the output resulting from the flowchart in FIG. 9. In one embodiment, the lattice represents the N most likely paths through the graph. That is, the lattice comprises another graph of the best non-pruned paths thus far. In each write destination state/arc operation in FIG. 9, the destination state/arc data is written to the lattice 1215.

Given the massive size of the data included in the WFST graph and associated state/arc data and the fact that graph access is extremely fragmented, an intelligent pre-fetching mechanism is employed to populate each of the cache memories 1210-1215 so that the data is available to the EUs 1201 when required. Thus, one embodiment includes an active state list prefetcher 1216 for prefetching the current 1210 and next 1211 active state lists; a score prefetcher 1217 for prefetching the acoustic model likelihood scores (e.g., GMM scores) 1212; a token prefetcher 1218 for prefetching the tokens 1213 containing the likelihood of the path that the token has traversed and the back pointer that can be used to trace back the path; a state data prefetcher 1219 for prefetching the state and arc information; and a lattice prefetcher 1220 for prefetching lattice data comprising the output for each audio frame.

In one embodiment, each prefetcher 1216-1220 determines which data should be prefetched based on the current data being processed including the current active state list 1210.

In one embodiment, the WFST decoder 1202 includes a dedicated gather/scatter memory management unit (MMU). As mentioned, the graph and other data may be stored in a very fragmented manner in memory. As such, the gather/scatter MMU 1221 may be used to efficiently gather and stream input data to each of the cache memories 1210-1215 and to scatter the resulting output (e.g., the lattice data 1215) back out to memory when required.

In one embodiment, a data decompression module 1222 is used to decompress pre-compressed graph data. As mentioned, WFST graphs may be extremely large (e.g., several gigabytes). Consequently the graph data, or portions of the graph data, may be compressed to reduce the memory footprint. In one embodiment, the data decompression module decompresses blocks of state elements that are compressed during the off-line generation of the state graph, enabling substantial reduction of the database footprint in memory. In one embodiment, the block compression/decompression algorithm is a simplified version of the standard Lempel-Ziv-Markov chain algorithm (LZMA), specifically adapted for short block de-compression (e.g., up to 1 KB). In one embodiment, only specified portions of the graph data are selected for compression. For example, the 20% most frequently utilized portions of the graph data (e.g., corresponding to the most common sounds/words/phrases) may not be compressed while the remaining 80% may be compressed. Thus, in this embodiment, the data decompression module 1222 will only be required to decompress certain portions of the graph data.

A configuration module 1223 stores configuration data specifying the desired operation of the WFST decoder 1102. In one embodiment, the configuration module comprises a set of programmable registers which may be programmed with values to specify sizes and locations of the data structures, etc.

Thus, using the WFST decoder 1102, for each speech frame, it is assumed that a feature vector was extracted and acoustic likelihood scores have been calculated. It is further assumed that a mapping from acoustic likelihood scores to HMM states has been stored in advance and that a WFST graph that describes all the ways the HMMs may be connected to model words/phrases/sentences in the language/grammar has been previously constructed and stored in memory. In one embodiment, the WFST decoder 1102 is invoked from software running on the processor cores 1104 through a function call that passes addresses of these data structures through a driver and initiates decoding for the current speech frame. The WFST graph is searched using the Viterbi algorithm and memory structures describing search state are updated to reflect the results of the current search step (as described in detail above). The best scoring candidate positions within the WFST graph are recorded along with their partial scores and all others are dropped (pruned). Software running on the processor cores 1104 is notified via the device driver that the decoding step for the current frame is complete. This process repeats until either all speech frames have been decoded or a partial result is required. At that point, the most likely path(s) through the WFST graph is(are) back-traced via software executed on the processor cores 1104, for example, by accessing the search state data structures in memory 1111 (or a cache). In one embodiment, the WFST output symbols are converted words using a simple word list lookup.

Using the combination of the GMM score accelerator 1101 and the WFST decoder 1102 as described above, the vast majority (e.g., 96%) of the speech recognition processing that normally happens on the processor cores is offloaded to very low power special purpose silicon. As a result, the processor can potentially spend the vast majority of time during speech recognition in a low power state, reducing power consumption and preserving battery life. The end result is uncompromised speech recognition processing that uses a very small fraction of one processor core (as opposed to multiple cores) and a very small fraction of the energy of today's implementations.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. An apparatus for performing speech recognition operations comprising:
an interface to communicatively couple the apparatus to a processor of the computing system over an interconnect fabric or bus;
prefetch logic to prefetch input data comprising acoustic likelihood scoring associated with sampling of a human voice and graph data including states and arcs connecting the states to form a graph, the states and arcs representing known acoustic, lexical, and language models of human speech;
a local cache to cache the input data;
execution logic to execute instructions to read the input data from the local cache and process the input data to determine likelihoods associated with different paths through the graph, the execution logic to select one or more paths through the graph having the highest likelihoods, the one or more paths selected representing a sound, word or phrase uttered by a human.

2. The apparatus as in claim 1 wherein the execution logic comprises a plurality of execution units to process the states and arcs of the graph using the acoustic likelihood scoring in parallel.

3. The apparatus as in claim 1 wherein the acoustic likelihood scoring comprises Gaussian mixture model (GMM) likelihood scoring data.

4. The apparatus as in claim 1 wherein processing the input data to determine likelihoods associated with different paths through the graph comprises:
propagating scores from current states to next states through the graph;
propagating scores for non-emitting arcs of the graph; and
pruning combinations of states and arcs with scores below a determined threshold.

5. The apparatus as in claim 4 wherein the threshold is determined by selecting N paths through the graph having the N highest likelihoods.

6. The apparatus as in claim 4 wherein the operations of propagating and pruning are performed in accordance with a Viterbi algorithm.

7. The apparatus as in claim 1 wherein the graph data including states and arcs connecting the states are formed in accordance with a hidden Markov model (HMM).

8. The apparatus as in claim 1 further comprising:
a gather/scatter memory management unit (MMU) to gather specified portions of the graph data from system memory and store the specified portions into the local cache and to scatter data representing the one or more paths selected by the execution logic to system memory.

9. The apparatus as in claim 1 wherein the execution logic is to construct lattice data representing the one or more selected paths.

10. The apparatus as in claim 1 further comprising:
a graph data decompression module to decompress portions of the graph data stored in system memory in a compressed format prior to storage in the local cache.

11. A system for performing speech recognition comprising:
a processor to perform feature extraction on a plurality of digitally sampled speech frames and to responsively generate a feature vector;
an acoustic model likelihood scoring unit communicatively coupled to the processor over a communication interconnect to compare the feature vector against a library of models of various known speech sounds and responsively generate a plurality of scores representing similarities between the feature vector and the models; and
a weighted finite state transducer (WFST) decoder communicatively coupled to the processor and the acoustic model likelihood scoring unit over the communication interconnect to perform speech decoding by traversing a WFST graph using the plurality of scores provided by the acoustic model likelihood scoring unit.

12. The system as in claim 11 wherein the WFST graph comprises states and arcs representing acoustic, lexical, and language models of known human speech.

13. The system as in claim 12 wherein the WFST decoder comprises:
prefetch logic to prefetch input data comprising the scores generated by the acoustic model likelihood scoring unit and specified portions of the WFST graph data including the states and arcs;
a local cache to cache the input data;
execution logic to execute instructions to read the input data from the local cache and process the input data to determine likelihoods associated with different paths through the graph, the execution logic to select one or more paths through the graph having the highest likelihoods, the one or more paths selected representing a sound, word or phrase uttered by a human captured in the digitally sampled speech frames.

14. The system as in claim 13 wherein the execution logic comprises a plurality of execution units to process the states and arcs of the graph using the acoustic likelihood scoring in parallel.

15. The system as in claim 11 wherein the acoustic model likelihood scoring unit comprises a Gaussian mixture model (GMM) likelihood scoring unit.

16. The system as in claim 13 wherein processing the input data to determine likelihoods associated with different paths through the graph comprises:
propagating scores from current states to next states through the graph;
propagating scores for non-emitting arcs of the graph; and
pruning combinations of states and arcs with scores below a determined threshold.

17. The system as in claim 16 wherein the threshold is determined by selecting N paths through the graph having the N highest likelihoods.

18. The system as in claim 16 wherein the operations of propagating and pruning are performed in accordance with a Viterbi algorithm.

19. The system as in claim 12 wherein the WFST graph including the states and arcs is formed in accordance with a hidden Markov model (HMM).

20. The system as in claim 13 wherein the WFST decoder further comprises:
a gather/scatter memory management unit (MMU) to gather specified portions of the WFST graph from system memory and store the specified portions into the local cache and to scatter data representing the one or more paths selected by the execution logic to system memory.

21. The system as in claim 13 wherein the execution logic is to construct lattice data representing the one or more selected paths.

22. The system as in claim 13 further comprising:
a WFST graph data decompression module to decompress portions of the graph data stored in system memory in a compressed format prior to storage in the local cache.
